(19) United States
(12) Patent Application Publication
(10) Pub. No.: US 2019/0313086 A1
(43) Pub. Date: Oct. 10, 2019

(54) SYSTEM AND METHOD FOR GENERATING VIRTUAL OBJECTS IN A REFLECTIVE AUGMENTED REALITY SYSTEM

(71) Applicants: Kristina Contreras, Beverly Hills, CA (US); Jonathan Rodriguez, Beverly Hills, CA (US)

(72) Inventors: Kristina Contreras, Beverly Hills, CA (US); Jonathan Rodriguez, Beverly Hills, CA (US)

(21) Appl. No.: 16/378,135

(22) Filed: Apr. 8, 2019

Related U.S. Application Data
(60) Provisional application No. 62/654,749, filed on Apr. 9, 2018.

(51) Int. Cl. H04N 13/32; G02B 26/08; G06T 19/00; G06T 7/20; G06T 7/70; G06F 3/01

(52) U.S. Cl. CPC H04N 13/32; G02B 26/0816; G06T 19/006; G06F 3/017; G06T 7/70; G06F 3/013; G06T 7/20

(57) ABSTRACT

A display that is capable of rendering objects to appear 3-D without use of special glasses or headsets is combined with a semi-reflective layer, such as a semi-silvered mirror. The display may be an auto-stereoscopic display that is mounted on the back side of the semi-silvered mirror. Camera systems generate image data representing an environment in front of the semi-silvered mirror and that image data is used to generate a three-dimensional model of the environment. Individuals may be identified and/or tracked using the image data. Eyes of the individual are tracked, and the eye tracking information is used with the auto-stereoscopic display to generate an augmented reality using the three-dimensional model. A viewer sees the augmented reality combined with the real world as reflected by the semi-silvered mirror.

### BACKGROUND

This application claims priority to U.S. Provisional Patent Application Ser. No. 62/654,749, entitled “Realiti,” filed on Apr. 9, 2018, the entire disclosure of which is incorporated herein for all purposes.

Augmented Reality (AR) systems provide an ability to combine and interact with virtual objects in a real environment. Augmented reality system can generate two-dimensional, and three-dimensional interfaces. When the augmented reality system generates a three-dimensional interface, special glasses or headsets may be required to experience the interface. Systems and methods are needed that support user interaction with AR systems without the need for special glasses or headsets.

The preceding description is not to be construed as an admission that any of the description is prior art relative to the present invention.

### SUMMARY OF THE INVENTION

A system includes a display that is capable of rendering objects to appear 3-D without use of special glasses or headsets. The display is combined with a semi-reflective layer, such as a semi-silvered mirror. The display may include an auto-stereoscopic display that is mounted on the back side of the semi-silvered mirror. Cameras (such as stereo cameras, structured light scanning systems and time-of-flight imaging systems) generate image data representing an environment in front of the semi-silvered mirror and that image data is used to generate a three-dimensional model of the environment. Particular individuals may be tracked and/or identified on the image data. Eyes of the individual are tracked, and the eye tracking information is used with the auto-stereoscopic display to generate an augmented reality that is combined with the real world as reflected by the semi-silvered mirror.

The foregoing specific aspects are illustrative of those which can be achieved and are not intended to be exhaustive or limiting of the possible advantages that can be realized. Thus, the objects and advantages will be apparent from the description herein or can be learned from practicing the invention, both as embodied herein or as modified in view of any variations which may be apparent to those skilled in the art. Accordingly the present invention resides in the novel parts, constructions, arrangements, combinations and improvements herein shown and described.

### BRIEF DESCRIPTION OF THE DRAWINGS

The foregoing features and other aspects of the invention are explained in the following description taken in conjunction with the accompanying figures wherein:

FIG. 1 illustrates aspects of the system according to an embodiment;

FIG. 2 illustrates aspects of the system according to an embodiment;

FIG. 3 illustrates aspects of the system according to an embodiment;

FIG. 4 illustrates aspects of the method according to an embodiment;

FIG. 5 illustrates aspects of the system according to an embodiment;

FIG. 6 illustrates aspects of the system according to an embodiment;

FIG. 7 illustrates aspects of the system according to an embodiment;

FIG. 8 illustrates aspects of the system according to an embodiment;

FIG. 9 illustrates aspects of the system according to an embodiment;

FIG. 10 illustrates aspects of the system according to an embodiment;

FIG. 11 illustrates aspects of the system according to an embodiment; and

FIGS. 12A-12C illustrate aspects of the system according to an embodiment.

It is understood that the drawings are for illustration only and are not limiting.

### DETAILED DESCRIPTION OF THE DRAWINGS

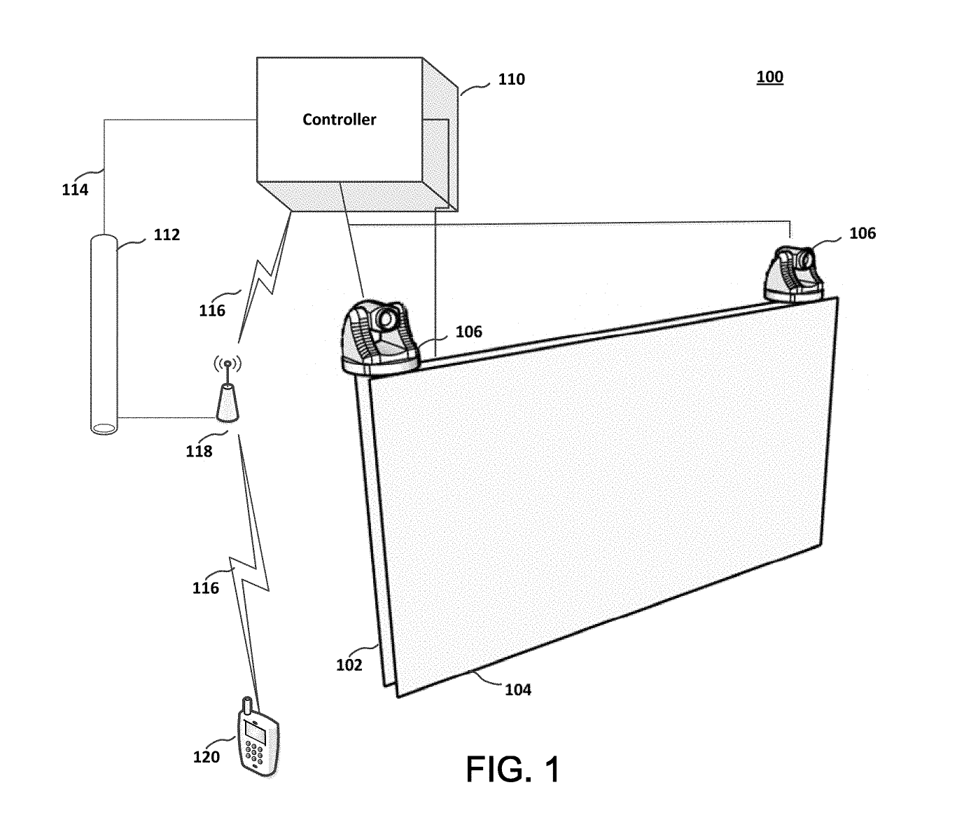

Referring to FIG. 1, system 100 includes a display 102 and a semi-reflective layer 104. The display 102 is located on the backside of reflective layer 104. The semi-reflective layer 104 allows some light to be transmitted through the layer, and some light to be reflected by the layer. A semi-silvered mirror is an example of a semi-reflective layer 104.

A semi-reflective layer might be a mirrored coating, a dielectric mirror coating, a deposited thin film, a multilayer deposited film, a vapor deposited film, a film deposited by sputtering, a film deposited by ion beam deposition, a film deposited on glass, a film deposited on plastic, and a flexible film deposited or laminated onto display 102.

A user standing directly in front of the semi-reflective layer 104 will see their own reflection because some light is reflected by semi-reflective layer 104. In addition, because some light will be transmitted through the semi-reflective layer the user will also see any image that is on display 102.

System 100 also includes a controller 110 connected to display 102. Controller 110 is generally a computer with memory, processor(s), input/output devices, network access devices and it may include video and audio capabilities, as well as image processing and image generating capabilities.

At least one camera or image generator 106 is part of system 100. By using a system that includes at least two cameras, a structured light scanning system or a time-of-flight imaging system, it is possible to generate image data and that image data can be processed to create depth maps of the environment. The image data can also be used for locating and identifying objects in the environment, such as a user. This can include detecting an object, determining that the object is a person, and facial recognition to identify that person as a particular user. Cameras 106 are electronically connected to controller 110, and may be part of display 102, semi-reflective layer 104 or they may be separate devices.

Controller 110 is connected to network 112, either with a wired connection 114, or with a wireless connection 116 and wireless access point 118. Electronic device 120 is able to wirelessly connect to controller 110 with a wireless connection 116 and wireless access point 118. Network 112 is any type of network, and includes a local area network (LAN), a wide area network (WAN), and the Internet. Wireless access point 118 is any type of wireless connection point, and includes devices that operate according to the relevant connection standard. Although only one wireless access point 118 is illustrated, system 100 may include multiple wireless access points 118 that are arranged in the environment to provide more robust coverage. With more than one wireless access point 118, controller 110 may be connected to one wireless access point 118, and handheld device 120 may be connected to a different wireless access point 118. Wireless connection 116 includes WiFi connections operating according to IEEE 802.11, ZigBee connections operating according to IEEE 802.15.4, UWB connections operating according to 802.15.3c, Bluetooth connections operating according to 802.15.1 and other similar wireless connection protocols.

Although not illustrated in FIG. 1, the network topology is flexible. For example, the system might include a wireless 4G or 5G network, and one or more of the components connects to that wireless 4G or 5G network without using a wireless access point 118. Communication traffic to and from controller 110 could occur over the wireless 4G or 5G network.

In system 100, controller 110 may have input/output capabilities, such as through a keypad, touch-pad, touch screen, or voice. Those input/output capabilities can be used to adjust parameters, preferences and generally interact with system 100. It is also possible that controller 110 makes interface connections available through an application interface and it is possible to adjust parameters, preferences and generally interact using another device, such as a handheld device 120. Handheld device 120 might be a tablet, or a smartphone, with the ability to communicate over a wireless connection 116. Handheld device 120 generally has and runs an operating system of its own, such as IOS or ANDROID. The operating system of handheld device 120 allows control and interaction with system 100 to facilitate use of the augmented reality. For example, a user who wants to try different makeup can select the particular makeup using handheld device 120, and that makeup information will be communicated to controller 110 of system 100. Controller 110 uses that selected makeup information with the image information generated by cameras 106 and eye tracking to generate an augmented reality interface that is displayed on display 102. The user is able to see that augmented reality interface as it is transmitted through semi-reflective layer 104 and the augmented reality interface can be superimposed with their reflection. Because display 102 is an auto-stereoscopic display the user can view the augmented reality interface as a 3-D interface superimposed with their own reflection.

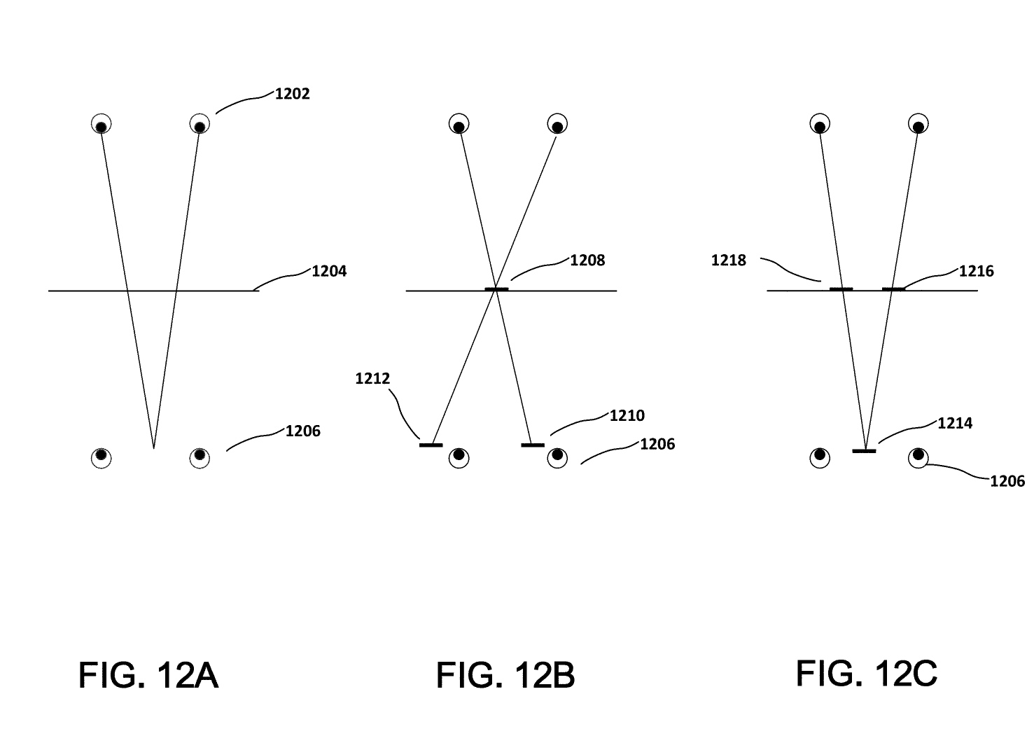

Controller 110 renders computer-generated images and those images are displayed by display 102. There are a number of types of display that might be used for display 102. In one example, display 102 might be a television type display or computer monitor type display. Other examples include OLED, LCD, microLED, plasma, CRT and others. These displays may include one or more of a reflector, a backlight, a diffuser, a polarizer, conducting layers, alignment layers, liquid crystal layers, a layer of organic LEDs, and a layer of inorganic LEDs. Some of these types of display render a two-dimensional flat image, which does not generally appear to have any depth or 3-D effects. There are instances where a two-dimensional display can create an illusion of depth or 3-D, such as when the user moves and the image on the display is adjusted based on the user's movement to appear three-dimensional. Similarly, a two-dimensional display can create an illusion of depth or 3-D when the display is moved and the user remains stationary. In this instance, the image on the display can be similarly adjusted to appear three-dimensional based on the movement of the display. However, for the instant invention, a two-dimensional display has some disadvantages. For example, there is a double-vision issue that is associated with binocular convergence. That issue is overcome with a proper 3-D display. This can be illustrated by referring to FIGS. 12A-12C, where a user 1202 on one side of a mirror 1204, sees their reflection 1206 at a distance behind the mirror, and the user's eyes focus on the reflection at the distance behind the mirror. If as illustrated in FIG. 12B the mirror is semi-transparent and has the ability to generate an image (1208) in the mirror plane, the user who has focused their eyes on the reflection 1206, will see two images (1210 and 1212). This is the double vision problem. If instead, the image is generated with an autostereoscopic display that can generate a 3-D image, and there is a left eye view 1216 and a right eye view 1218, then as illustrated in FIG. 12C the user will see a single object 1214 at the same depth as their reflection 1206.

Where there is no movement of the user or the display, the appearance of depth or 3-D generally requires that each of the user's eyes see a slightly different image. As an example, some movie theaters are able to display 3-D effects. For these movie theaters, the movie viewers are given special glasses that allow their left eye and their right eye to see slightly different images. This is the same principle as binocular vision, and those different images create the illusion of depth or 3-D.

To create the illusion of depth or 3-D in a computer-generated image without special eyeglasses the display itself must somehow create and direct different images to the left and right eyes of the user. This type of display can be referred to as an auto-stereoscopic display. The auto-stereoscopic display uses position information that corresponds to positions of the user's left and right eyes, and directs different images, or causes different images to be viewed by the left and right eyes. Those different images create the illusion of depth or 3-D.

An auto-stereoscopic display has components that are configured to direct different images to the left and right eye of a single user. Where the display is able to direct different images to the left and right eyes of multiple users, it may be referred to as an auto-multiscopic display. Some of the technologies used in auto-stereoscopic and auto-multiscopic displays include a lens array, a lenslet array, parallax barriers, pin-hole array, and light-field displays. The lens array can be a lenticular lens array that is straight or slanted and can be referred to as a 1D array, or it might be a 2D array of individual spherical lenses.

A parallax barrier uses a set of aligned opaque bars. The opaque bars have a space between each bar, and the bars block certain pixels from view allowing only certain pixels to be visible through the space. With a known geometry of the opaque bars and the display pixels with respect to a user's viewpoint, it is possible to create different left and right eye images. The basic parallax barrier technique has been known since the early 1900's. In most instances a user will not tilt their head when viewing the display, so it is desired to generate the left and right eye images in a horizontal orientation. This means that the parallax barriers are usually oriented in a vertical direction. A parallax barrier is relatively inexpensive and easy to fabricate, but it does reduce the brightness of the display, as compared to a lenticular lens array.

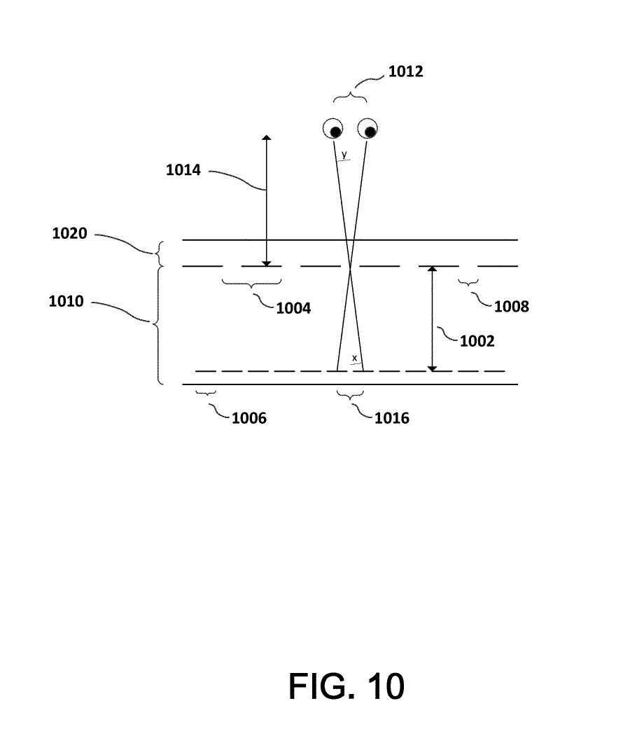

As illustrated in FIG. 10, slits in the parallax barrier allow the viewer to see only left image pixels from the position of their left eye, and right image pixels from the position of their right eye. Design of the parallax barrier that is part of a barrier substrate (1020) considers at least the following parameters: 1) the pixel-barrier separation distance (1002); 2) the parallax barrier pixel pitch (1004); 3) the pixel aperture (1006) and the parallax barrier slit width (1008).

As the parallax barrier moves closer to the pixels, the angle of separation between the left and right images increases. For a stereoscopic display, the left and right images must hit the user's left and right eyes. The pixel-barrier separation distance d (1002) can be derived as follows: n sin x=sin y, where n is the index of refraction of the display panel (1010). Using a small angle approximation,

$$sin y \approx \frac{e}{2 r} and sin x \approx \frac{p}{2 d} ,$$

where e is the eye separation (1012), r is the viewing distance (1014), p is the pixel pitch (1016), and d is the pixel-barrier separation (1002). From this the pixel-barrier separation d (1002) can be determined:

$$= \frac{rnp}{e} .$$

For a typical auto-stereoscopic display with pixel pitch of 65 micrometers, eye separation of 63 mm, viewing distance of 30 cm and refractive index of the display of 1.52, the pixel-barrier separation should be about 470 micrometers.

The pitch of the parallax barrier should be about two times the pixel pitch. However for a number of reasons, better performance is achieved when the barrier pitch (1004) is about 0.1% smaller than twice the pixel pitch (1016).

The parallax-barrier slit width (1008) plays a role in brightness and crosstalk. With a small slit width, light passing through the slits is diffracted heavily, which causes crosstalk. Crosstalk is interference that exists between the left eye view and the right eye view. The left eye sees some of the image intended for the right eye superimposed on the left eye view, and vice versa. With high quality 3D images, the amount of crosstalk should be no greater that 1-2%. Small slit width also causes reduced brightness. With a large slit width, light passing through the slit does not diffract as much, but the wider slits create crosstalk due to geometric ray paths. However, the wider slit width does not reduce brightness as much as narrow slits.

Position of the parallax barrier, either in front of or behind the LCD pixels is also a design consideration.

In a parallax barrier system without viewer tracking, the viewer must position themselves in a location so that the left eye view is seen by the left eye, and the right eye view is seen by the right eye. When the viewer is tracked, there is additional freedom, and the parallax barrier can be adjusted so the left eye and right eye views are always directed to the user's respective left and right eyes. The adjustment of the parallax barrier can be mechanical or electronic, by shifting the barrier relative to the pixels. Additional details are provided herein on how a viewer can be tracked.

It is also possible to time multiplex the parallax barrier system, which allows each eye to see a full resolution of the display. In the first time cycle, the slits are arranged in the conventional way as described above (left eye sees left eye view and right eye sees right eye view). In the second time cycle, the positions of the slits are changed, and in the new barrier position, the right eye sees pixels that were hidden in the first time cycle. The same is done for the left eye in the second time cycle. This allows each eye to see the correct image from half the pixels in the first time cycle, and the correct image from the other half of the pixels in the second time cycle. When the switch is faster than about 50 Hz, it is not noticeable to the user.

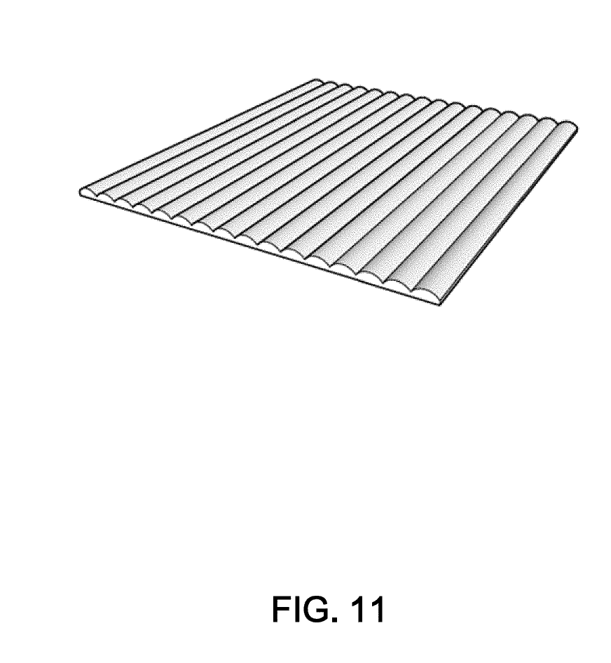

Like parallax barriers, a lenticular lens array can also be used to produce an auto-stereoscopic display. FIG. 11 illustrates an example of a lenticular lens array. This technique, also developed in the early-mid 1900's, generally arranges the lenses in the same vertical direction as the parallax barriers would be arranged. Each lenticular lens is wider that an individual pixel, covering multiple pixels. As a user moves horizontally, the lenticular lens array will cause different pixels to be visible to the user.

For simplicity of manufacturing, lenticular lens arrays are often semi-spherical in cross-section. However, a semi-spherical lens only approximates an ideal lens shape. Spherical aberration is one of the disadvantage of using semi-spherical shapes. If instead of a semi-spherical cross-section, the lenticular lens array has an elliptically shaped cross-section, the image quality is significantly improved. Advances in lenticular lens arrays for visual display, by R. Barry Johnson, (SPIE 2014) describes some of the issues related to manufacturing and performance of different lenticular lens shapes.

Pinhole arrays can also be used to produce an auto-stereoscopic display. These are a bit like a lens array arranged in a 2D configuration, and each pinhole blocks all light except the single ray that passed from the display through the pinhole to the user's eye. Because the pinhole array and the display pixels are in a fixed configuration, and the user will only see the single ray that passes from the display through the pinhole to the user's eye, there is no need to track the user's head or eyes. A pinhole array is also relatively inexpensive and easy to fabricate. However, the optical efficiency is low as compared to the optical efficiency of a 1-dimensional parallax barrier, a lenticular lens array or even a two-dimensional lens array. When the brightness is reduced by the pinhole array, the display intensity behind the pinhole array must be increased to accommodate and provide a realistic or life-like image.

In addition to parallax barriers and lens arrays, other techniques that can be used to produce an auto-stereoscopic display include holographs, volumetric displays and depth-fused displays. Like the differences between parallax barriers, and lenticular lens arrays, these other techniques have respective strengths and weaknesses. A holograph uses a coherent light source, such as a laser to reconstruct the wavefront of an object by using interference among different light rays. Generally the viewing angle and resolution of a holograph are limited as compared to other auto-stereoscopic display technologies. Holographs are generally monochromatic, so rendering a full color image is difficult or impossible with current technologies. A volumetric display reconstructs 3D images within a ‘volume’ where the reconstructed image is viewable from any angle. This technology does not generally use flat-panel displays, relying instead on rotating or moving components (e.g., mirrors and screens). In view of these additional required components, this technology may not be ideally suited for the current invention. A depth-fused display uses multiple layered 2D images, and that provides an accommodation cue for the user by using the fusing effect between the layered 2D images. This may be an enhancement for techniques that rely only on binocular disparity, and may be a technology that has applications in the current invention. Design and Implementation of Autostereoscopic Displays, Lee, Park, Hong and Hong, SPIE Press (2016), provides additional background and information on auto-stereoscopic technologies that are appropriate for the current invention.

Some of the same technologies used in auto-stereoscopic image display, can be adapted to multi-user viewing. For instance, it is possible to design the system so it provides multiple individual viewpoints, and users located at those individual viewpoints will perceive the illusion of depth or 3-D. For example, Lee describes multi-view and integral imaging displays. In a multi-view display, the rays are mainly sampled with consideration for the viewers. As such a multi-view display provides high-quality 3-D images with a large depth expression for fixed observers. In the integral imaging display, the rays are sampled mainly with consideration for the reconstructed objects, and as a result the integral imaging display moderate-quality 3-D images are provided with moderate depth expression over a wide range of viewing area.

There are different techniques that can be used to track the eyes of a user. One technique makes use of reflected infrared (IR) because the retina of humans is highly reflective for IR. This is similar to the phenomenon that causes the eyes of an animal to be visible at night when a light shines on the animal and the animal is looking toward the light. In an IR eye tracking system, an infrared transmitter sends IR light in the direction of the user and that IR light is reflected by the user's retina and received by an IR receiver. Generally, this type of system includes at least one infrared transmitter and at least one infrared detector or receiver that work in combination. The transmitter transmits some form of IR, such as an IR pulse, and that IR is reflected by the retina. The reflected IR is received or detected by the IR detector. In this way, a user looking directly toward or nearly directly toward this type of IR transmitter/receiver pair will be detected and the eyes can be tracked because of the two points of reflected IR received by the IR receiver.

Although it is preferable to track the user's pupils, it is also possible to track the location of the user's eyes, without tracking the actual pupils. This could use IR, or it might use image data that tracks the user's eyes with respect to the rest of the head. It is also possible that only the user's head is tracked, and the eye positions are estimated from the user's head location.

Face detection, tracking and recognition also play a particular role in the invention, allowing the system to detect the face of a user, track that face as the user moves in the environment, and recognize the particular user from their face. Furthermore, the known location of the user's face and/or facial landmarks may be sufficient in order to accurately estimate the position of the user's left and right eyes, with sufficient accuracy to generate the left eye viewpoint and right eye viewpoint information required by the present invention. Beyond the important use case of generating the left eye viewpoint and right eye viewpoint information, face recognition can also be used to recognize individual user identity, allowing customization and unique interactions with that particular user. A number of different face detection, tracking and recognition techniques are available, but one technique in particular seems to be appropriate to the invention. This technique, sometimes referred to as multi-task cascaded convolutional neural networks, uses an architecture with at least three tasks. Those three tasks include 1) face classification, 2) bounding box regression, and 3) facial landmark localization. The paper entitled Joint Task Detection and Alignment using Multi-task Cascaded Convolutional Networks, by Zhang, Zhang and Li (2016), explains those three tasks in some detail.

The first task, face classification, produces potential windows that may include faces using a shallow convolutional neural network (CNN). Zhang refers to this task as Proposal Network (P-Net), where candidate windows and their bounding box regression vectors are obtained, and the estimated bounding box regression vectors are used to calibrate the candidates. Then, a non-maximum suppression (NMS) merges highly overlapped candidates.

In the second task and using a more complex CNN, the potential windows are refined, rejecting many of the windows that do not include faces. Zhang refers to this task as Refine Network (R-Net), where a large number of false candidates are rejected, bounding box regression is used to calibrate, and NMS is used to merge candidates.

In the third task, the refined results are processed using a more powerful CNN, which refines the results and produces facial landmark positions. Zhang refers to this task as Output Network (0-Net), which uses a technique similar to the second task and outputs five facial landmark positions.

Training of the neural networks for each of the three tasks, uses different algorithms. The first task, face classification, can be approached as a two-class classification problem. A cross-entropy loss is used for each sample xᵢ:

Lᵢ^{det}=−(yᵢ^{det} log(pᵢ)+(1−yᵢ^{det})(1−log(pᵢ))) (1)

where pᵢ is the probability indicating a sample is a face, and yᵢ^{det}ϵ{0,1} is the ground-truth label.

In the second task, bounding box regression, offsets are predicted for each candidate window between the candidate window and the nearest ground truth (i.e., the bounding box left top, height and width). In this task, the learning objective is characterized as a regression problem, using a Euclidian loss for each sample xi:

Lᵢ^{box}=∥ŷᵢ^{box}−yᵢ^{box}∥₂² (2)

where ŷᵢ^{box} is the regression target from the network, and yᵢ^{box} is the ground-truth coordinate. There are four coordinates including the left top, the height, the width, and thus yᵢ^{box} ϵ R⁴.

In the third task, facial landmark localization, the problem is again characterized as a regression problem and Euclidean loss are minimized:

Lᵢ^{landmark}=∥ŷᵢ^{landmark}−yᵢ^{landmark}∥₂² (3)

where ŷᵢ^{landmark} is the coordinate for a facial landmark obtained by the network and yᵢ^{landmark} is the ground-truth coordinate. In this task there are five facial landmarks including left eye, right eye, nose, left mouth corner and right mouth corner. Here yᵢ^{landmark} ϵ R¹⁰.

Training of the CNN uses different types of images in the process. These include face, non-face and partially aligned face images. Because some of the training images do not include faces, some of the loss functions above are not used. As an example, with a training image having only background regions, only (1) is used, with (2) and (3) being set as 0.

As described by Zhang, online hard sample mining is adaptive and used in the training process. In each mini-batch the loss computed in the forward propagation phase is sorted and the top percentage (e.g., 70%) is selected as hard samples. The gradient is only computed from those samples in the backward propagation phase. This ignores easy samples, which are not as helpful in strengthening the detector during training.

With an auto-stereoscopic display, the 3-D effect is generally optimized for one viewer/user. Other viewers/users who view the display may not see any 3-D effect, or it may be distorted. If the display is an auto-multiscopic display, then different viewers/users will see different perspectives. With this type of display, it is possible that all the viewers see the same scene and same augmented reality objects, but from different perspectives. It is also possible with an auto-multiscopic display that individual viewers/users see completely different scenes. For example multiple users at a gym might see exercise routines that are personalized for each of them, but not involving any of the other viewers/users. It is also possible with an auto-multiscopic display to provide some users different views of the same scene while other viewers/users have completely different scenes.

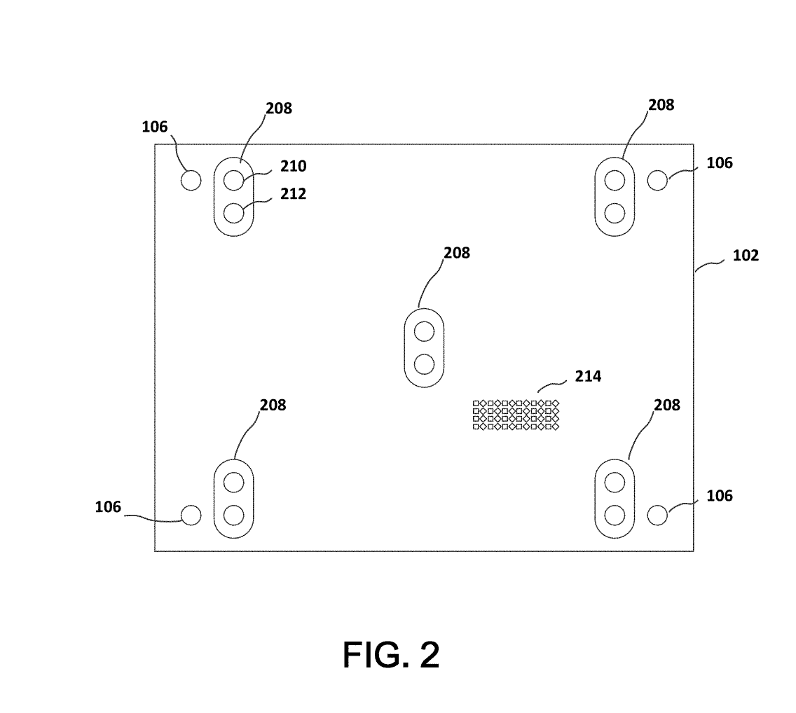

FIG. 2 illustrates example display 102. One or more cameras 106 may be located near the edges or corners of display 102. One or more IR transmitter/receiver pairs 208 may be located near the one or more cameras 106, and/or they may be located in a central part of display 102. The IR transmitter/receiver pairs include an IR transmitter 210, and an IR receiver 212. Although illustrated as larger objects in FIG. 2, the cameras 106 and IR transmitter/receiver pairs 208 may be very small, and placed so that they replace only a few pixels of display 102. Placing cameras 106 near the perimeter allows a longer baseline between each lens and can provide greater depth resolution, at the expense of larger areas where there may be limited stereoscopic coverage closer to the surface of semi-reflective layer 104. Placing some IR transmitter/receiver pairs 208 near the center of display 102 can improve the eye tracking since most user interaction will be focused near the center of display 102.

Cameras 106 and IR transmitter/receiver pairs 208 can be used to generate image data that is processed to develop depth measurements or depth maps. When stereo cameras are used the image data is processed using algorithms to identify points or pixels in each image that correspond to the same object or point in real space, and then those point pairs are used to generate a disparity map. The disparity map represents corresponding pixels from the image pair that are shifted (most often horizontally) between the individual images. There are a number of techniques and algorithms that have been developed to perform this disparity mapping, and the algorithms used for generating stereo vision disparity maps have been generally classified as using either a local or a global approach.

In a local approach, the disparity computations depend on pixel intensity values within a predefined window. In a local approach, the disparity map value assignment is through a winner take all optimization. A disparity value with the minimum cost is assigned to each pixel. The matching cost is aggregated in a sum or average over the predefined window. By using only local information, the computational complexity is low.

In a global approach, the problem is treated as a global energy function for all disparity values. In this approach there is a data term, which penalizes solutions that are inconsistent with the target data, and a smoothness term, which enforces the piecewise smoothing assumption with neighboring pixels. The smoothness term retains smoothness in disparity among pixels in the same region. The disparity map is generated by assigning similar depth values to neighboring pixels. Although the global approach generates good results, it is computationally complexity is high, and for that reason the global approach many not be suitable for a real time system.

In most instances for the local and global approaches, a cost criterion measures the extent of matching between two pixels. There are a number of different algorithms that have been proposed and used, which include: 1) Absolute Differences, which aggregates differences in luminance or intensity values between pixels in the left and right images; 2) Squared Differences, which aggregates the squared differences between reference pixels in the left and right images; 3) Feature Based Techniques, which attempts to establish correspondences only for similar feature points that can be unambiguously matched; 4) Sum of Absolute Differences, which considers the absolute difference between the intensity of each pixel in the reference block and that of the corresponding pixel in the target block; 5) Sum of Squared Differences, which sums the squares of the differences in pixel intensity values between two corresponding pixels in the window; 6) Normalized Cross Correlation, which compensates for differences in gain in bias within the window; 7) Rank Transform, which calculates cost based on the absolute difference between two ranks; and 8) Census Transform, which translates the comparison results between a center pixel and neighboring pixels within a window. These algorithms can be implemented entirely in software, or in a mix of software and hardware, such as field programmable gate arrays.

In addition to stereo camera imaging, there are other techniques for developing depth information, such as a time-of-flight system or a structured light system. In contrast to stereo camera imaging systems, time-of-flight and structured light systems are generally active systems, and transmit light energy that is coded or modulated in some way. Because that coding or modulation might be visually distracting, many of the time-of-flight and structured light systems use infrared light, instead of visible light.

Time-of-flight systems can provide very accurate depth measurements. Most time-of-flight systems achieve this accuracy by comparing a phase shift between the modulated light and a reflection of the modulated light. Although very accurate, time-of-flight systems can be more expensive, and the devices may be more complex than other depth measurement systems. The phase of the reflected signal can be recovered using a cross-correlation. By sampling at fixed intervals, (such as 0 deg, 90 deg, 180 deg and 270 deg) The phase and amplitude at each pixel can be calculated from those samples, and the distance and confidence image determined from the data. Time-of-flight systems are limited in the maximum distance that they will compute an unambiguous distance. Beyond that unambiguous distance, the system is unable to determine whether the measured reflection corresponds to a close distance or a further distance with the same phase shift. The Melexis MLX75023 is an example time-of-flight sensor that incorporates some of these techniques, with features that might be appropriate for the instant invention.

Structured light systems use a projector to emit a light pattern, and an offset camera to capture the light pattern as it is reflected by the object. By knowing the projected light pattern, and the comparing that known light pattern to the light pattern captured by the camera from the object, it is possible to determine depth information using a form of triangulation. Most structured light systems require calibration, which can be a drawback. The patterns used in structured light can be classified as single-point patterns, single-line patterns, and coded patterns. With a single-point pattern, the point is scanned over the entire image volume. When the system uses a single-line pattern, the entire image volume can be scanned in one direction, although most systems will scan in multiple directions. This is faster, and less computationally expensive than a single-point scanning system. A coded pattern system can obtain all depth information in single image operation, which is faster than a single-point or a single-line pattern. Some of these aspects of structured light depth measurement systems are described in Depth Measurement Based on Infrared Coded Structured Light, by Jia, Zhou and Gao (Hindawi, 2014).

FIG. 2 also illustrates an example configuration for a pixel array 214 of an auto-stereoscopic display. Pixel array 214 directs light toward a user's left eye and a user's right eye. Depending on the type of display, parallax barriers or small lenses may be placed in front of some pixels so they are not clearly visible based on where the user's eye is positioned.

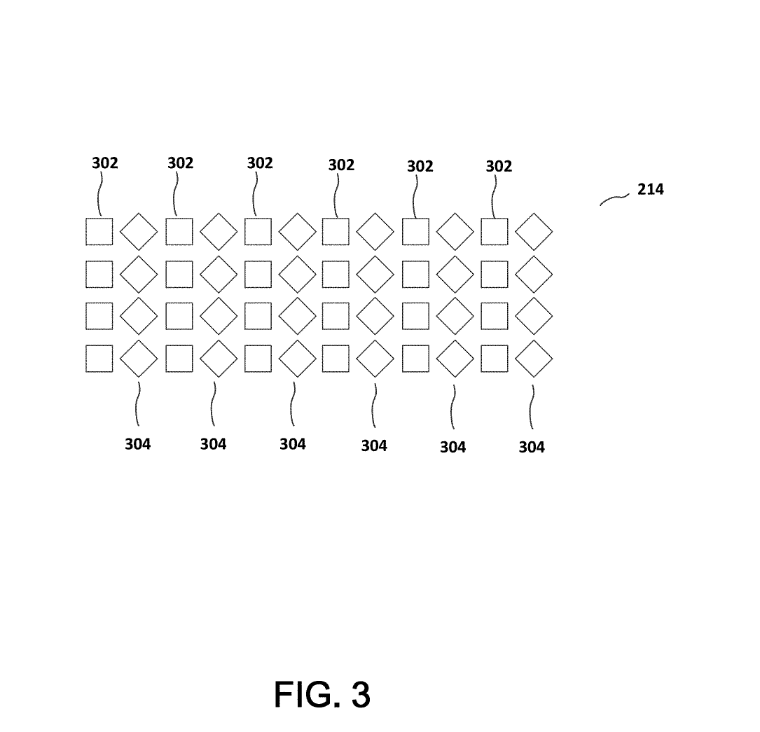

Referring to FIG. 3, pixel array 214 includes a first group of pixels 302 that are configured to direct light toward a first eye of a user, and a second group of pixels 304 that are configured to direct light toward a second eye of the user.

System 100 may include audio output capabilities, such as one or more speakers, and audio input capabilities, such as one or more microphones. The audio capabilities may be integrated in display 102, or controller 110, or they may be separate components. System 100 may also include sensors that use audio, radio, or light transmission and reception to detect, locate and/or identify objects in the environment. Like the audio capabilities, these sensors may be integrated in display 102, or controller 110, or they may be separate components.

System 100 may include a touch sensor, configured for user interaction. The touch sensor may be part of display 102 or semi-reflective layer 104. The touch sensor might include a capacitive touch detection layer, or a proximity detector that is able to detect an object such as a finger that is in close proximity to the display, without making physical contact.

System 100 may also include one or more cameras. Those cameras can be used to image the user and the environment of the user. The cameras may be sensitive to a single wavelength of light (monochrome) or sensitive to a range of wavelengths (color). Depending on the number of pixels, and lens quality the cameras may provide higher resolution imagery. If the cameras are sensitive to IR, such as IR detectors that are used for eye tracking, the resolution may be lower. When multiple cameras are used it is possible to generate a three-dimensional model of the environment using the image data generated by those cameras. That three-dimensional model can then be used in an augmented reality display. As an example, the cameras capture the environment of the user. Using the image data captured by those cameras, the system identifies objects in the environment of the user. Those objects might include a table. The augmented reality system can determine the position of the table in the environment and generate a virtual object such as a vase that can be positioned in the virtual environment on top of the table even though the vase is not present in the physical environment. A user viewing their environment as reflected by the semi-reflective layer 104 will see the table as reflected by the semi-reflective layer, and they will also see the vase as a virtual object on top of the table.

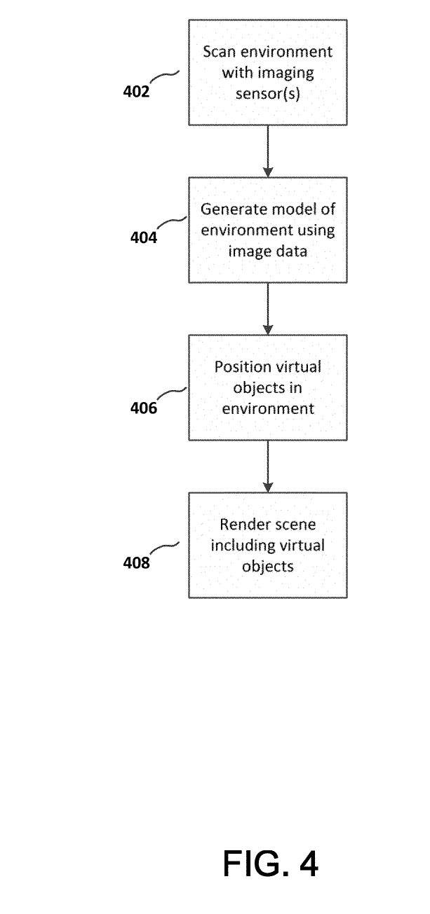

Referring to FIG. 4, steps in the process to generate an augmented reality using display 102 and semi-reflective layer 104, include understanding, at step 402 the three dimensional scene in the environment of display 102 and semi-reflective layer 104. In step 402, sensors, such as cameras 106, are used to scan the environment. As discussed elsewhere, cameras 106 may be conventional RGB color imaging cameras, IR sources/receivers, IR cameras, structured light transmitters/sensors, or time of flight sensors. The image data that is generated in step 402 by cameras 106 is processed and used by system 100 at step 404 to generate a model of the environment, including objects in the environment. This can include detecting and identifying users in the environment.

At step 406, system 100 calculates the desired position(s) in the environment for virtual objects. These positions may be calculated as absolute positions with respect to the environment, or as positions that are relative to physical objects that have been detected in the environment. For example, if a physical table is detected in the environment, system 100 may calculate a position for a virtual lamp as located at coordinates corresponding to the upper surface and the center of the physical table. System 100 may determine that the table is not likely to move and there is no need to continuously track the position of the table and adjust the position of the lamp to match that movement. In this way, position of the virtual lamp is static in the environment.

In another example, if a person is detected in the environment, system 100 may calculate a position for a virtual tie as located adjacent to and covering the upper button of the shirt worn by the person. As the person moves in the environment, system 100 calculates updated positions for the tie so it moves with the person, appearing to be attached to the person.

Once the scene, environment and positions of virtual objects to be placed in the scene have been determined, system 100 at 408 renders the virtual objects so the virtual objects will be displayed in the correct positions by display 102. The rendering process includes determining which particular pixels of display 102 should be activated. The pixels that need to be illuminated for viewing by the left eye are different from the pixels that need to be illuminated for viewing by the right eye. An auto-stereoscopic or auto-multiscopic display can accomplish this. The process can be considered a constraint satisfaction process, and there are multiple different algorithms or processes that will generate the same or similar results. For every point in the virtual objects, the display should illuminate to the user's left eye the pixel located such that, if the virtual object were a real object, the photons from that point in the object would touch that pixel location in the semi-reflective surface on the path as the photons travel from the object, to the semi-reflective surface, and reflect into the user's left eye. Similarly, the display should illuminate to the user's right eye the pixel located such that, the photons from that point in the object would touch that pixel location in the semi-reflective surface on the path as the photons travel from the object, to the semi-reflective surface, and reflect into the user's right eye.

The rendering operation (casting a ray to/from (between) the user's eye and the virtual object) is accomplished on a per-point basis, and it is calculated either for every point in the object, or for every pixel in the display.

At least five different techniques can be used to solve this problem. Those techniques include 1) the law of reflection (Angular Formulation) where the angle of incidence equals the angle of reflection; 2) the law of reflection (Vector Formulation) where R=I−2(I dot N)N. In this technique, R is the reflected ray, I is the incident ray, N is a unit vector normal to the surface of the semi-reflective layer, pointing out of the semi-reflective layer and into the scene. —is subtraction and dot is the dot product; 3) altering the position of the virtual object to be “behind” the mirror, while keeping the user's eye on the “real-world” side of the mirror; 4) altering the calculated position of the user's eye to be “behind” the mirror, while keeping the virtual object on the “real-world” side of the mirror; and 5) tracking the user's eyes using one coordinate system that is either left-handed or right-handed and computing the position of the virtual object using a different coordinate system that has the opposite handedness, and then grafting the two coordinate systems into a new, fictitious coordinate system that contains both the virtual object and the user's eyes and has the mirror plane at the plane where the coordinate systems are grafted together.

Included below is example code with comments, written in the Swift programming language. The example code implements techniques 1), 2), 3) and 4).

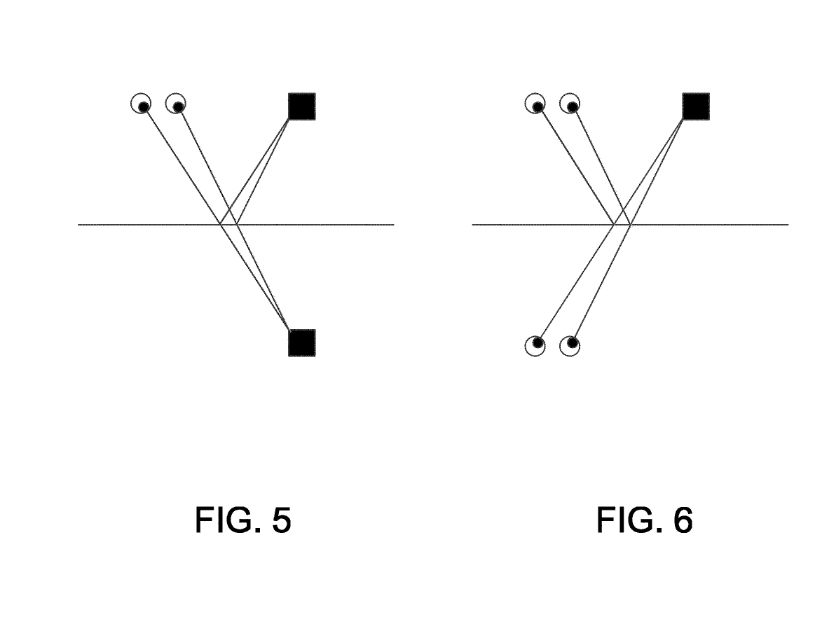

Technique 3) is illustrated in FIG. 5, while technique 4) is illustrated in FIG. 6. In techniques 3) and 4) as illustrated in FIGS. 5 and 6, if one of the coordinate axes is normal to the semi-reflective surface, then the sign of that axis can be reversed (negated). It is also possible to negate any one coordinate axis, and then rotate as appropriate to restore the correct location and orientation of the semi-reflective surface plane. It is also possible to negate all three coordinate axes, and then rotate as appropriate to restore the correct location and orientation of the semi-reflective surface plane. It is also possible to swap values of any two coordinate axes (e.g., if X=5 and y=−3, swap so that X=−3 and y=5), and then rotate as appropriate to restore the correct location and orientation of the semi-reflective surface plane. Once the reflection operation is completed, a ray can be cast from the virtual object to the user's eye, or vice versa, and that ray will intersect through the surface of the semi-reflective surface at a specific pixel, which is the pixel that should be illuminated.

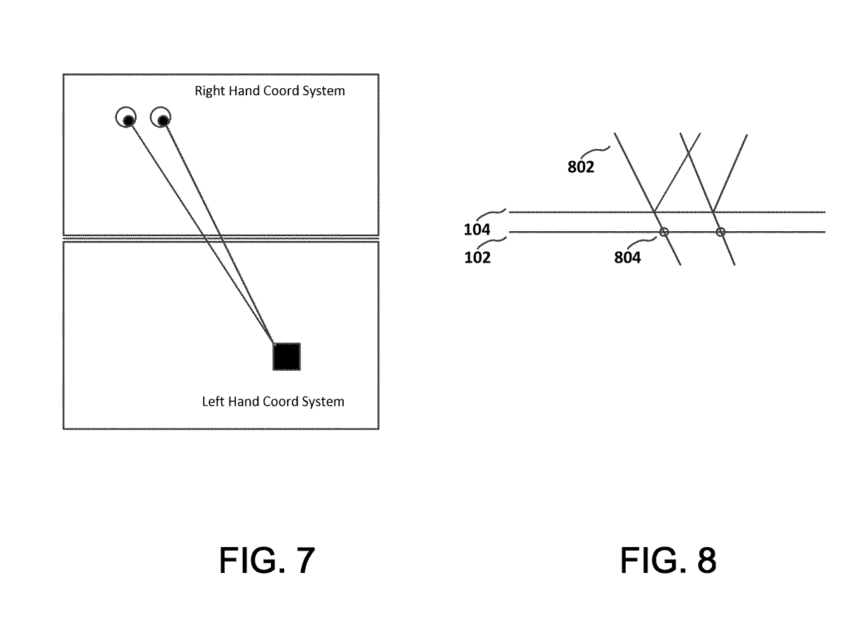

Technique 5) is illustrated in FIG. 7.

In many of the examples above, the objective is a 3-D view including the augmented reality object. It is also possible that the techniques can be used for less than 3-D, such as 2.5D or simply 2D. When less than 3-D techniques are used, flat sprites, or vector graphics may be appropriate. This may reduce the computational complexity as the process may not even require computation of rays or vectors at all.

In the discussions above, creating a dark augmented reality object presents some unique challenges. Light from the environment will be reflected by the semi-reflective layer, so creating an object or area that is less bright (darker) that the reflected environment is difficult. It is possible to brighten the entire display around the dark area in a gray glow to make a specific set of ‘cut-out’ pixels that are darker than the gray glow. The ‘cut-out’ pixels will appear comparatively darker. Using this technique, the entire semi-reflective layer has a gray glow, and this gray glow can be masked on the edges by covering the area with a decorative frame, trim or bezel. It is of course possible that the edges are not masked and the gray glow ends sharply at the edge. Alternatively, the gray glow can be tapered in a gradient at the edges. In a further alternative, a gray glow can be created around a virtual object, with the glow tapering in a gradient away from the virtual object. This way, the pixels that are not illuminated will appear comparatively darker than pixels that are illuminated. When these light emission techniques are combined with the features of an auto-stereoscopic display, it is possible to create areas of darker/darkness specifically directed at a user.

Light Emission Module

Display 102 is by itself a light emitting display. However, there may be instances where further light emission is used to augment a scene, such as by adding light to represent virtual objects, or effects. Effects might include secondary effects, such as a splash of soft light representing the glow emitted by a virtual table lamp. The light emitting elements of display 102 might be located around the perimeter, in a bezel, or they might be configured to enhance or illuminate the entirety of the scene at a baseline brightness, excluding certain pixels that are supposed to be darkened.

Light Attenuation Module

The light emission module enhances areas of the image that are dark by increasing the brightness of other surrounding areas. A similar effect can be achieved by attenuating the light that is reflected from the semi-reflective layer. Examples of these techniques include a transmissive spatial-light modulator that allows or attenuates the passage of light through a pixel.

In some of the discussions, there is an assumption that the semi-reflective layer and the display are at the same depth or plane. In most instances, there will be some distance between them. This can be addressed with a slight adjustment. Referring to FIG. 8, a ray 802 that goes from the user's eye to the calculated reflection point on the semi-reflective layer surface is extended further in the same direction until it intersects 804 the pixel plane in the display 102.

When the display generates the augmented reality object at a position behind the semi-reflective layer, the user's eye focuses at the position behind the semi-reflective layer. However, the pixels themselves are in the plane of the display, which is closer to the user. This can cause the pixels themselves to appear blurry. This can be mitigated by over-sharpening the virtual content before it is displayed on the display, so that when the user's eyes focus beyond the display, the combination of over-sharpening and blur will somewhat balance out, cause the virtual content to appear in focus.

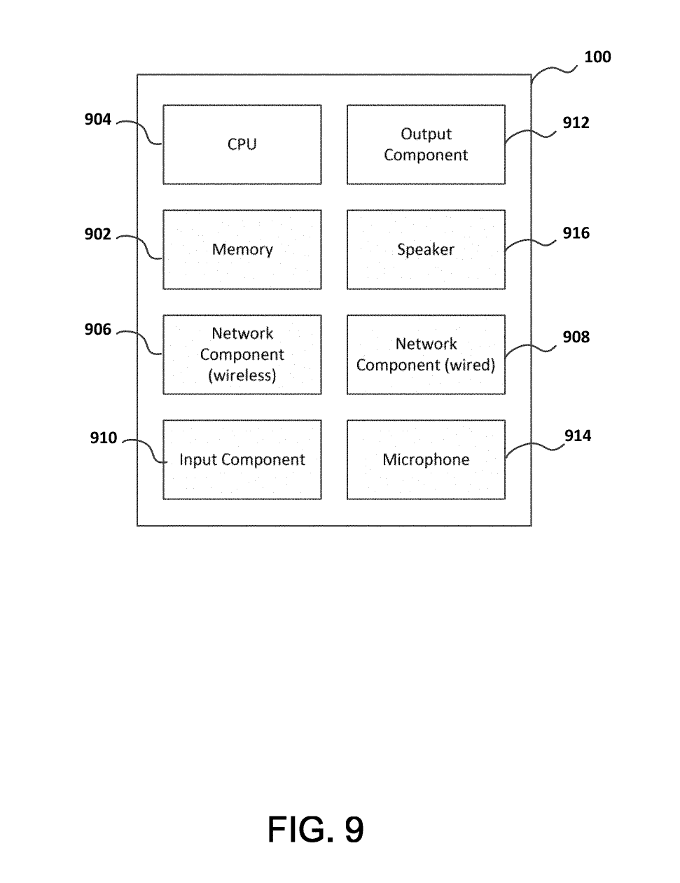

System 100 includes a number of components, as illustrated in FIG. 9. Those components include at least memory 902, to store executable program code, and other data, at least one processor 904, and one or more network connections 906, 908. Controller 110 may also include input devices 910, such as keyboards, pointing devices, and touch screens, output devices 912, such as displays, and printers. Other components may include microphones 914 and speakers 916.

Example Applications for System 100.

A system configured as described above, can be used for a number of applications, including making and receiving video calls, getting updated weather information, viewing news, interactive VR exercise, and VR makeup assistance to name a few examples. The system can allow a user to create custom makeup in augmented reality, along with instructions on how to apply the makeup. Augmented reality related to makeup might include 3D graphics that are registered to the user's face to identify what part of the face is the next part to apply makeup on. The system has applications in skin care, where using computer vision skin health issues might be detected (wrinkles, pimples, dryness, color changes that may indicate skin cancer, etc.) The system has applications in exercise, such as where the augmented reality provides guidance on how the exercise might be improved with changes in position etc.

In another application the system can be used in fashion and shopping applications. A mirror wall with augmented reality fashions allows a user to see how a particular item might look on them or in a different environment. This can also apply to shopping for cars and other forms of transportation.

Although illustrative embodiments have been described herein in detail, it should be noted and will be appreciated by those skilled in the art that numerous variations may be made within the scope of this invention without departing from the principle of this invention and without sacrificing its chief advantages. For example features that appear in one embodiment of a particular figure are also applicable to embodiments that are illustrated in other figures.

Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

1. An augmented reality display system comprising:
a semi-reflective layer, having a first surface oriented toward a viewer position, and a second surface opposite the first surface;
an auto-stereoscopic display that is mounted adjacent to the second surface of the semi-reflective layer and configured to display an image through the first surface of the semi-reflective layer, the image being viewable from the viewer position;
a camera configured to generate physical environment information in a vicinity of the viewer position;
an algorithm configured to use image data from the camera or another sensor to track the location of the viewer's eyes, generating left eye viewpoint information and right eye viewpoint information; and
a controller for generating a virtual 3-D object, and rendering the virtual 3-D object using the auto-stereoscopic display, the left eye viewpoint information, the right eye viewpoint information, and the physical environment information so that the virtual 3-D object appears to be located at a first position in the vicinity of the viewer position as the vicinity of the viewer position is reflected by the first surface of the semi-reflective layer.

2. The augmented reality display system of claim 1, further comprising a light attenuation module to improve realistic rendering of black or dark virtual 3-D objects, the light attenuation module blocking or subtracting reflected light.

3. The augmented reality display system of claim 1, wherein the auto-stereoscopic display further comprises an additive light component to improve realistic rendering of black or dark virtual 3-D objects, the additive light component increasing brightness levels of certain features.

4. The augmented reality display system of claim 1, wherein the camera further comprises at least one of multiple apertures, time of flight sensors and structured light sensors, the camera configured to capture and generate a 3-D model of the vicinity of the viewer position.

5. The augmented reality display system of claim 1, wherein the controller is further configured to generate the virtual 3-D object according to a law of reflection with an angular formulation, where an angle of incidence corresponds to an angle of reflection.

6. The augmented reality display system of claim 1, wherein the controller is further configured to generate the virtual 3-D object according to a law of reflection with a vector formulation, using a reflected ray, an incident ray, and a normal vector of the semi-reflective layer.

7. The augmented reality display system of claim 1, wherein the controller is further configured to generate the virtual 3-D object by altering a position of the virtual 3-D object to be behind the semi-reflective layer, while left and right eye viewpoint information correspond to positions located in front of the semi-reflective layer.

8. The augmented reality display system of claim 1, wherein the controller is further configured to generate the virtual 3-D object by altering positions of the left eye viewpoint information and the right eye viewpoint information to be behind the semi-reflective layer, while the virtual 3-D object corresponds to a position in front of the semi-reflective layer.

9. The augmented reality display system of claim 1, wherein the controller is further configured to generate the virtual 3-D object by generating the left eye viewpoint information and the right eye viewpoint information using a first coordinate system, and generating the virtual 3-D object using a second coordinate system, and grafting the first and second coordinate systems into a third coordinate system with the semi-reflective layer at the plane where the first and second coordinate systems are grafted.

10. The augmented reality display system of claim 1, further comprising a handheld device, the handheld device configured to communicate with and provide commands to the controller.

11. The augmented reality display system of claim 1, further comprising a light emission module, the light emission module configured to increase brightness of the real world outside of the auto-stereoscopic display.

12. The augmented reality display system of claim 1, wherein the algorithm configured to use image data from the camera or another sensor to track the location of the viewer's eyes is implemented by the use of RGB camera data.

13. The augmented reality display system of claim 1, wherein the camera includes at least an infrared transmitter and an infrared receiver.

14. The augmented reality display system of claim 1, further comprising an eye tracker that includes at least an infrared transmitter and an infrared receiver.

15. A method for generating an augmented reality display, comprising:
generating image data representing an environment of a first device;
generating a model of the environment and at least one object in the environment using at least the image data;
determining a first position in the environment for placement of a virtual 3-D object;
generating left eye viewpoint information and right eye viewpoint information; and
rendering the virtual 3-D object so it appears to be located at the first position when viewed on an auto-stereoscopic display that is mounted adjacent to a second surface of a semi-reflective layer, the auto-stereoscopic display configured to display the virtual 3-D object through the semi-reflective layer when the virtual 3-D object is viewed from a first surface of the semi-reflective layer.

16. The method according to claim 15, further comprising:
generating stereo image information using an image sensor;
generating a depth map using at least the stereo image information; and
generating the model of the environment and the at least one object using at least the stereo image information and the depth map.

17. The method according to claim 15, further comprising performing facial recognition on the at least one object to identify a particular user.

18. The method according to claim 15, further comprising:
generating reflected infrared information using at least a first infrared receiver;
determining the left eye viewpoint information using at least the reflected infrared information; and
determining the right eye viewpoint information using at least the reflected infrared information.

19. The method according to claim 15, further comprising:
receiving makeup information; and
rendering the virtual 3-D object based at least on the makeup information.

20. The method according to claim 15, further comprising:
receiving user preference information; and
determining the virtual 3-D object based at least on the user preference information.

21. The method according to claim 15, further comprising:
tracking movement of an individual based on the image data; and
rendering the virtual 3-D object during the movement so it appears to be located at a constant position relative to the individual.
